(19) United States
(12) Patent Application Publication
(10) Pub. No.: US 2005/0235558 A1
(43) Pub. Date: Oct. 27, 2005

(54) Biograss

(76) Inventor: Jaime Ramiro Carrillo, Fort Mill, SC (US)

Correspondence Address: Jaime Carrillo, 351-B Sweetgum Dr., Fort Mill, SC, 29715, US

(21) Appl. No.: 10/830,194

(22) Filed: Apr. 22, 2004

(51) Int. Cl. A01C 1/04

(52) U.S. Cl. 47/56

(57) ABSTRACT

An Invention which utilizes one layer or two layers of biodegradable mean which support and hold seed, bonded by organic adhesive. The invention contemplates the forms of flakes, strips, straws and grains. The biodegradable mean is made of new or recycled soft paper, a composite of agricultural byproducts or combinations of them. The seed are mainly grass, but the invention contemplates the use of native seed or a cocktail of seed. The organic adhesive is made of natural glue or syrup (corn, rice, potato) mixed with organic elements (N, P, K) to provide nutrients to the seed and soil system. The invention may be use to establish grass for erosion control, to generate turf on geotextiles in situ or transplanted, turf for golf courses, subdivisions, and, on all natural or synthetic surfaces where a vegetative layer is required.

### CROSS REFERENCE TO RELATED APPLICATIONS

| Patent No. | Inventor | Date |
|---|---|---|
| 3,292,307 | Finn, Charles O. | Dec. 20, 1966 |
| 4,219,966 | McCallister, William J. | Sep. 2, 1980 |
| 4,716,679 | Heard, Richard A. | Jan. 5, 1988 |
| 5,884,570 | Lincoln, James A. | Mar. 23, 1999 |

### STATEMENT REGARDING FEDERAL SPONSORED RESEARCH & DEVELOPMENT

None

### FIELD OF THE INVENTION

This invention relates to a new, practical, useful home lawn, garden improvement and erosion control product capable of starting a lawn or a vegetable growth layer on soil or any synthetic surface where it is applied. The product and method utilize an organic sheeting support, an organic adhesive and seeds.

The intention of the invention is to provide a simple, economical and practical means of starting in situ a new lawn or vegetable growth on soil or other synthetic surfaces.

### BACKGROUND OF THE INVENTION

Research indicates that, at present, most people either hand spread or mechanically spread grass and fertilizer on the soil surface, leaving the seed susceptible to the actions of rain, wind, or wildlife.

Alternatively, the process to cover the seed with hay or straw to form a barrier against the erosion agents requires additional hand labor for installation and final cleaning up, and the rate of seed germination is low.

Previous solution to this problem have included the use of expensive pre-grown lawn turf installation; blowing an aqueous solution of water, fertilizer, compost, and seed onto the targeted growth area (U.S. Pat. No. 3,292,307, Finn), casting of grass growth concentrate directly onto the land (U.S. Pat. No. 4,219,966, McCallister); and introduction of sod slurry mixtures in various forms and configurations (U.S. Pat. No. 4,716,679, Heard) and (U.S. Pat. No. 5,884,570, Lincoln); together with a host of home methods and remedies developed by individual users over the course of many years. However, each of these methods requires either large and bulky equipment or other apparatus to use, or is cost prohibitive for small users.

Biograss alleviates these shortcomings by allowing the introduction of a mean directly onto the soil or synthetic surface in a self-contained protective wrap which will biodegrade in a relatively short period, leaving a successful vegetative layer or turf onto the soil applied.

Biograss alleviates the need for costly dispersing equipment and there is no need to clean up any hay, straw, bark, or other mulching mediums which may have been used to protect new growth seeds. To the best of the inventor's knowledge, there is no similar product on the market today which encompasses these features.

### BRIEF SUMMARY OF THE INVENTION

Biograss can be summarized as that product and method of promoting grass or other seed growth, which utilizes seeds layered between biodegradable sheets held together with an organic adhesive. Once manufactured, the Biograss can be delivered in rolls, flakes, strips, straws or grains for the application onto the soil or surface where grass or vegetable layer is to be grown. To activate the product, it requires proper watering or irrigation until the grass or vegetable growth has matured.

The organic sheeting is the mechanical means to support the erosion agents, made of biodegradable fibers (paper, coir, grained straws, grained grass leaves, etc), the design will come in convenient size, shape, color, commercial or institutional drawing.

The organic adhesive will stick the seeds to the organic sheeting. The organic adhesive is made of natural glue (corn syrup, rice syrup, latex, etc.) and its compounds will hold fertilizer (nitrogen, phosphorus, potassium, etc). The seeds could be from one or several kinds, native or exotic, commonly grass seeds to develop turf.

### BRIEF DESCRIPTION OF THE DRAWINGS

FIG. 1 shows diagramatically the general composition of the Biograss. It illustrates the layers of organic sheeting, the organic adhesive to bond the seeds to the mechanical support (organic sheets or fibers) and the seeds.

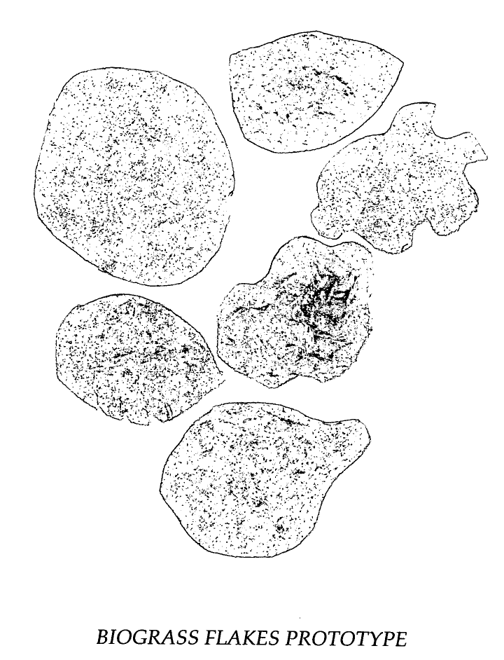

FIG. 2 illustrates the Biograss Flakes, the design will come in convenient size, shape, color, commercial or institutional drawing.

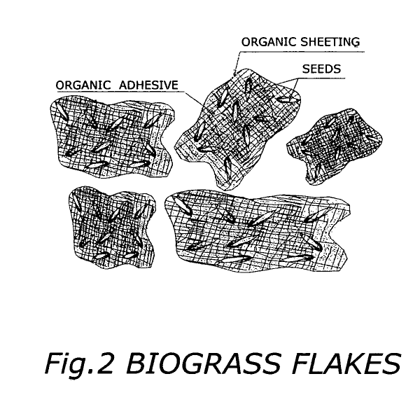

FIG. 3 shows the Biograss Strips, the design will come in convenient size, shape, color, commercial or institutional drawing.

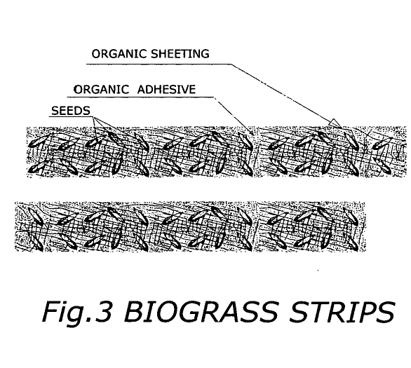

FIG. 4 shows the Biograss Straws, the design will come in convenient size, shape, color, commercial or institutional drawing, in this special product, the Biograss could be mix with natural straws in order to support the straws recycling.

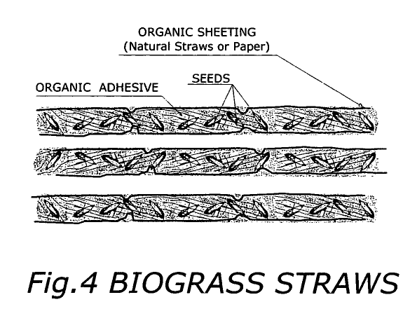

FIG. 5 illustrates the Biograss Grains, the design will come in convenient size, shape, color, commercial or institutional drawing The Biograss Grains could be made or mix with natural fibers or natural and septic byproducts.

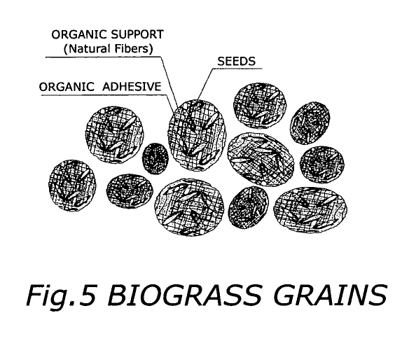

1. A composition made of organic sheeting, organic adhesive and seeds, for use in starting and placing in situ a lawn or a vegetative layer, onto a soil surface or synthetic surface.

2. A composition according to claim 1 made in the forms of rolls, flakes, strips, straws and grains.

3. A composition according to claims 1 and 2, made of one or a combination of cellulosic material, chopped paper, chopped straws, chopped grass leaves, sawdust, wood chips, bark chips, bagasse, peat moss, leaves chips, soft paper, coir, biodegradable fibers, clean biodegradable recycled fibers, new biodegradable synthetic fibers and wherein the cellulosic material is chopped into long and short fibers.

4. A composite according to claims 1 and 2, made of one or a combination of several natural glue, corn syrup, rice syrup, fertilizer, latex, resins and wherein the result composite be biodegradable.

5. The use of one or a combination of more kinds of seed, placed on one or between two layers according to claim 3 and glued with the composite according to claim 4.

6. A method of claims 1 and 2 wherein the finished composition consisting of one or two layers according to claim 3, glued according to claim 4, with one or several kinds of seed to start and place in situ a lawn or a vegetative layer, onto a soil surface or synthetic surface, designed to develop vegetative layer or turf for erosion control.

7. A composite according to claims 1 and 2, which its design allows drawing or shaping onto the composite surface commercial or institutional logos to be used in environmental publicity.

8. A composite according to claims 1 and 2, which will go through mechanical and biological process aid by the water action: to keep the necessary moisture to activate the dormant seed and dissolve gradually the composite according to claims 1 and 2, bringing cohesion, supplying nutrients to the plants, softening the composite according to claims 1 and 2 to facilitate the roots penetration and bounding to the soil or synthetic surface, accelerating the biodegradable process of the composite according to claims 1 and 2, and bringing as final result a erosion control vegetative layer, turf or decorative flowered carpet.
